(19) United States
(12) Patent Application Publication
(10) Pub. No.: US 2005/0074737 A1
(43) Pub. Date: Apr. 7, 2005

(54) Cultural ambassador exchange method and system

(76) Inventors: Alan Young, Chapel Hill, NC (US); David Young, Chapel Hill, NC (US); Mary Breen, Raleigh, NC (US); Debra Martin, Swannanoa, NC (US); Gregory S. Hopper, Raleigh, NC (US)

Correspondence Address: MACCORD MASON PLLC, 300 N. GREENE STREET, SUITE 1600, P. O. BOX 2974, GREENSBORO, NC, 27402, US

(21) Appl. No.: 10/679,735

(22) Filed: Oct. 6, 2003

(51) Int. Cl. G09B 25/00

(52) U.S. Cl. 434/365; 705/14

(57) ABSTRACT

A system and method for management of participants within an education-based cultural exchange program, wherein the system and method provide for a multiplicity of participants to share cultural-related information and other information not specifically related to the cultural distinctions of a respective participant within a phased program, the phases including at least acclimation, teaching, and sharing phases, and the program further providing for self-administration of administrative matters, tracking participants and information within the program framework and timeframe, and auditing the program.

### BACKGROUND OF THE INVENTION

(1) Field of the Invention

The present invention relates generally to human resources management and, more particularly, to management of participants within an education-based cultural exchange program.

(2) Description of the Prior Art

Typically, cultural exchange programs involve student participation wherein the exchange student travels to a host country and lives with a family, attends school, and participates in community activities to conduct a predetermined limited amount of time, such as one year, of formal studies within the context of a foreign culture, which may include a new language as well as new cultural information. Generally, the exchange student does not provide any formal input or sharing in a structured manner to the host community other than social sharing; predominantly, these types of prior art programs provide for a unilateral exchange wherein the host community transfers information through the environment, the host family, and the formal education that is typically not modified from what is provided to local students.

Systems have been developed to provide for electronic means of instructing students in remote locations, as in U.S. Pat. No. 6,615,020, including software for course curricula, student tracking, student attendance, and progress, as well as audit trail means for tracking student progress and maintaining records on the time periods and dates of a student's instructional course periods.

Additionally, computer systems have been developed to provide electronic means for enabling a user in a child category of users to interact with content having at least one of educational and cultural materials and for parental input as to the content available to the child user(s), as in U.S. Pat. No. 5,907,831 issued May 25, 1999 to Lotvin.

Also, prior art includes agent-based instructional systems and methods such as disclosed in U.S. Pat. No. 5,727,950 issued Mar. 17, 1998 to Cook, wherein the system includes computer-based and/or computer readable medium having instructional content thereon for providing interactional instruction of student(s); and U.S. Pat. No. 6,427,063 issued Jun. 30, 2002 to Cook for a system and method for interactive, adaptive, and individualized computer assisted instruction. However, these and related patents provide merely for computer-aided learning and/or teaching, instructional methods, and the like, without providing, teaching or otherwise disclosing any system or method for providing a structured cultural exchange program including automated, self-administration of the program by its participants, wherein the program is administered in the context of an education-based system of instruction and provides for two-way exchange, apart from simply providing an automated, interactive system.

Furthermore, there exists no prior art relating to a system and method for management of participants in a cultural exchange program, in particular where such systems are automated via computers and networks, and where the program provides for teacher exchange within an education-based cultural exchange program.

Thus, there remains a need for a system and method for management of participants within an education-based cultural exchange program, in particular where the system and method are automated within the context of a network of computers.

### SUMMARY OF THE INVENTION

The present invention is directed to a system and method for management of participants within an education-based cultural exchange program, wherein the system and method provide for a multiplicity of participants to share cultural-related information and other information not specifically related to the cultural distinctions of a respective participant within a phased program, the phases including at least acclimation, teaching, and sharing phases, and the program further providing for self-administration of administrative matters, tracking participants and information within the program framework and timeframe, and auditing the program.

In a preferred embodiment, the system and method are automated within the context of a network of computers, such as a local area network or a wide area network like the Internet or world wide web.

Accordingly, one aspect of the present invention is to provide a system for cultural ambassador exchange including a multiplicity of participants within a program for cultural ambassador exchange, in particular within the context of an educational system, the participants further including at least one host, cultural diplomats, corresponding mentor/advisors, and students, wherein the program provides for the exchange of cultural information in addition to teaching standard curriculum information, the program being administered and the participants managed over a predetermined period, wherein the period includes at least three distinct phases: acclimation, teaching, and sharing of the information.

Another aspect of the present invention is to provide a method for operating a cultural ambassador exchange comprising the steps of: providing a program for cultural ambassador exchange; registering participants for participating in the program; administering the program; and the participants participating in the program according to predetermined phases; wherein the participants further including at least one host, cultural diplomats, corresponding mentor/advisors, and students; wherein the program provides for the exchange of cultural information and the predetermined phases include at least three distinct phases, including acclimation, teaching, and sharing of the information.

Still another aspect of the present invention is to provide an automated system and method as set forth herein for permitting remote access to the program information and/or administration thereof by the participants via a network of computers.

These and other aspects of the present invention will become apparent to those skilled in the art after a reading of the following description of the preferred embodiment when considered with the drawings.

### BRIEF DESCRIPTION OF THE DRAWINGS

FIG. 1 is a schematic view of the system constructed according to the present invention and a flow chart showing steps according to the present invention.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

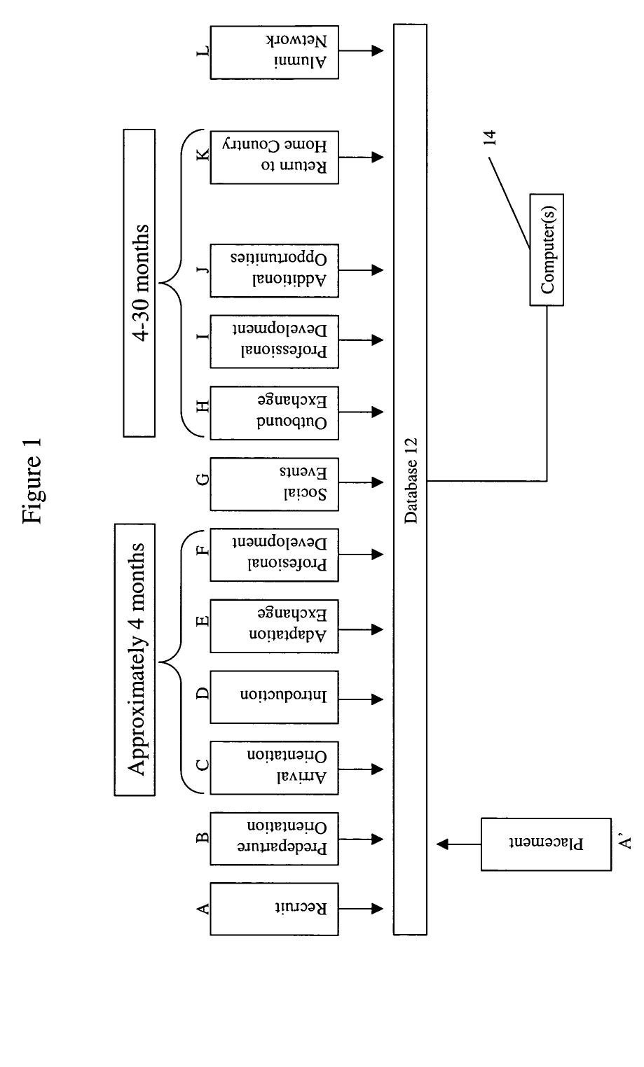

Referring now to the drawings in general, the illustrations are for the purpose of describing a preferred embodiment of the invention and are not intended to limit the invention thereto. As best seen in FIG. 1, a schematic diagram illustrating the present invention is shown, including an automated system, generally referenced 10, for managing participants in a cultural ambassador exchange program including a network of computers 14, preferably including a database 12, and/or data processing systems having a memory, a processor, a display and user interface, and software running on the system, wherein the network is constructed and configured for communication therebetween such that at least one user is capable of accessing information about the program from the computers.

Also shown in FIG. 1 is a flow chart of activities and/or information provided into the database, according to a method provided by the present invention including the steps of: providing an automated system for managing participants in a cultural ambassador exchange program including a network of computers and/or data processing systems having a memory, a processor, a display and user interface, and software running on the system, wherein the network is constructed and configured for communication therebetween such that at least one user is capable of accessing information about the program from the computers, as illustrated in the schematic portions of FIG. 1; (A) recruiting new participant(s); (A′) placing the participant(s) within the cultural ambassador exchange program; (B) providing predeparture orientation to participant(s), which may preferably occur via remote access to the system by the participant(s) and/or be a self-administered or self-guided step; (C) providing arrival orientation to participants; (D) providing an introduction to the program to the participants; (E) providing adaptation exchange, for permitting the cultural ambassador participant(s) to adapt to the host environment; (F) providing professional development for the participant(s); (G) providing social events for the cultural ambassador participant(s) to attend and/or the cultural ambassador participant(s) attending social events, which may occur at more than one point and/or be more than one step that occurs throughout the program, and which may facilitate other steps, such as the adaptation exchange step; (H) providing outbound exchange for the cultural ambassador participant(s) to deliver information to the host, to students, and/or to non-cultural ambassador participant(s) of the program; (I) providing professional development for the participant(s); (J) providing additional opportunities for the cultural ambassador participant(s); (K) the cultural ambassador participant(s) returning to their respective home countries; (L) providing an alumni network for cultural ambassador participant(s) who have participated in the program. These steps illustrated in FIG. 1 are preferred steps of one embodiment of the present invention that provides at least one step in the three phases or stages of the program as set forth in the following description. Modification, omission, or addition of steps to the method as illustrated will be understood to one of ordinary skill in the art to be possible while still including the present invention as set forth herein in the description and claims.

The present invention provides a system for cultural ambassador exchange including a multiplicity of participants within a program for cultural ambassador exchange, the participants further including at least one host, cultural diplomats, corresponding mentor/advisors, and students, wherein the program provides for the exchange of cultural information in addition to teaching standard curriculum information, the program being administered and the participants managed over a predetermined period, wherein the period includes at least three distinct phases: acclimation, teaching, and sharing of the information. Preferably, the program is administered within the context of an educational system and the participants include teachers.

The program further includes exchange elements that preferably provide for a two-way information exchange among participants, more particularly exchanging cultural information that includes at least cultural diplomat-specific cultural information, and additionally host-specific information as well. Other exchange elements include teaching information such as instruction consistent with a curriculum within an education-based environment. A tool kit may be used to facilitate the cultural diplomat's instruction or teaching of this information. Also, optionally, the cultural diplomat may also participate in an exchange element on a speaker circuit whereby the cultural diplomat shares information regarding the cultural ambassador exchange program, including personal experiential and professional information relating to the cultural diplomat's participation within the program.

Also, preferably the system is provided as an automated system for managing participants in a cultural ambassador exchange program including a network of computers and/or data processing systems having a memory, a processor, a display and user interface, and software running on the system, wherein the network is constructed and configured for communication therebetween such that at least one user is capable of accessing information about the program from the computers. The data processing system(s) may also preferably include at least one server computer for hosting a database that contains information relating to the program, including but not limited to information associated with each of a multiplicity of participants within the program for cultural ambassador exchange.

The automated system and method advantageously provides for the program being self-administered by the participants, including administrative matters, such as tracking and auditing, as well as registration and/or application to the program, and providing feedback or referrals. Preferably the automated system and method provide for an online or web-based that includes the Internet, however, a networked system that is smaller or provides for increased security or more limited access may also or alternatively be employed.

The participants of the program include at least one host, a plurality of cultural diplomats and corresponding mentor/advisors, noting that the mentor/advisors may not exist in directly proportionate numbers to the cultural diplomats, and students, where the program is administered in the context of an education-based environment or system. This program according to the present invention advantageously provides for the exchange of cultural information, and in particular, where administered within an educational system or environment, this cultural-related information is provided by the participant cultural diplomats in addition to teaching standard curriculum information as required within the education program.

Furthermore, the program is preferably administered and the participants managed over a predetermined period, wherein the period includes at least three distinct phases: acclimation, teaching, and sharing of the information. Also, in an embodiment of the present invention, the program further includes an exchange period for the participation of the at least one cultural diplomat. This period preferably totals about two years. In the preferred phases of this exchange period, the time is divided about equally between the phases, i.e., the acclimation phase, teaching phase, and sharing phase each last between about four to about six months. Where the optional speaker circuit occurs, additional time is preferably allotted or allocated to the exchange period.

A method for operating a cultural ambassador exchange comprising the steps of: providing a program for cultural ambassador exchange; registering participants for participating in the program; administering the program; and the participants participating in the program according to predetermined phases; wherein the participants further including at least one host, cultural diplomats, corresponding mentor/advisors, and students; wherein the program provides for the exchange of cultural information and the predetermined phases include at least three distinct phases, including acclimation, teaching, and sharing of the information. Preferably, the program is administered within the context of an educational system and the participants include teachers, which are ideally the cultural ambassadors or diplomats, such that the cultural diplomats provide, according to the phased program of the present invention, cultural information in addition to teaching standard curriculum or other educational material not otherwise related to the particular cultural background of the cultural diplomats.

Where the method of operating the system is preferred to be automated, the method further includes the step of providing a data processing system having a memory, a processor, a display and user interface, and software running on the system, wherein the system is connected to computers within a network for communication therebetween such that at least one user is capable of accessing information about the program from the computers, such that the method is automated using the data processing system for providing remote access by the participants to the administration and/or participation of the program.

Certain modifications and improvements will occur to those skilled in the art upon a reading of the foregoing description. By way of example, a point-based reward program that awards points to the cultural ambassador participants to encourage improved performance and/or participation levels. Also, computer readable medium including information relating to the system and/or method of the present invention, its administration, and/or instructions for providing the present invention are also considered within the scope of the present invention. A computer readable medium and/or computer executable program code residing on a computer readable medium and/or a computer for providing a cultural ambassador exchange program including information relating to the program, such as the exchange of cultural information; curriculum information and/or teaching information; and program administration, wherein the program is to be administered and the participants managed over a predetermined period, wherein the period includes at least three distinct phases: acclimation, teaching, and sharing of the information.

All modifications and improvements have been deleted herein for the sake of conciseness and readability but are properly within the scope of the following claims.

1. An automated system for cultural ambassador exchange comprising:
a multiplicity of participants within a program for cultural ambassador exchange, the participants further including at least one host, cultural diplomats, corresponding mentor/advisors, and students,
a data processing system having a memory, a processor, a display and user interface, and software running on the system, wherein the system is connected to computers within a network for communication therebetween such that at least one user is capable of accessing information about the program from the computers,
wherein the program provides for the exchange of cultural information in addition to teaching standard curriculum information, the program being administered and the participants managed over a predetermined period, wherein the period includes at least three distinct phases: acclimation, teaching, and sharing of the information.

2. The system according to claim 1, wherein the program is administered within the context of an educational system and the participants include teachers.

3. The system according to claim 1, wherein the program includes a two-way information exchange wherein the cultural diplomats experience an adaptation exchange for the receipt of information from the host and an outbound exchange for the sharing of information from the cultural diplomat.

4. The system according to claim 1, wherein the adaptation exchange includes cultural information relating to the host.

5. The system according to claim 1, wherein the outbound exchange includes cultural information relating to the cultural ambassador(s).

6. The system according to claim 1, wherein the outbound exchange includes information selected from the group consisting of: educational information, cultural information, professional information, and combinations thereof.

7. The system according to claim 1, wherein the exchange period occurs over a period of between about 4 months to about 30 months.

8. The system according to claim 1, wherein the exchange period phases of acclimation, teaching, and sharing of the information occur over a period of time that is approximately equivalent.

9. The system according to claim 1, wherein the system is self-administered by the participants.

10. The system according to claim 1, wherein the system further includes means for administration, tracking, and auditing of the program and/or its participants.

11. An automated system for managing participants in a cultural ambassador exchange program comprising:
a data processing system having a memory, a processor, a display and user interface, and software running on the system, wherein the system is connected to computers within a network for communication therebetween such that at least one user is capable of accessing information about the program from the computers;
the system further including information relating to a multiplicity of participants within a program for cultural ambassador exchange, the participants further including at least one host, cultural diplomats, corresponding mentor/advisors, and students, wherein the program provides for the exchange of cultural information in addition to teaching standard curriculum information, the program being administered and the participants managed over a predetermined period, wherein the period includes at least three distinct phases: acclimation, teaching, and sharing of the information.

12. A method for operating a cultural ambassador exchange comprising the steps of:
providing a program for cultural ambassador exchange;
registering participants for participating in the program;
administering the program;
the participants participating in the program according to predetermined phases;
wherein the participants further including at least one host, cultural diplomats, corresponding mentor/advisors, and students;
wherein the program provides for the exchange of cultural information and the predetermined phases include at least three distinct phases, including acclimation, teaching, and sharing of the information, and
providing a data processing system having a memory a processor, a display and user interface, and software running on the system, wherein the system is connected to computers within a network for communication therebetween such that at least one user is capable of accessing information about the program from the computers, such that the method is automated using the data processing system for providing remote access by the participants to the administration and/or participation of the program.

13. (canceled).

14. The method according to claim 12, wherein the program is administered within the context of an educational system and the participants include teachers.

15. The method according to claim 12, further including the steps of:
(A) recruiting new participant(s);
(A′) placing the participant(s) within the cultural ambassador exchange program;
(B) providing predeparture orientation to participant(s), which may preferably occur via remote access to the system by the participant(s) and/or be a self-administered or self-guided step;
(C) providing arrival orientation to participants;
(D) providing an introduction to the program to the participants;
(E) providing adaptation exchange, for permitting the cultural ambassador participant(s) to adapt to the host environment;
(F) providing professional development for the participant(s);
(G) providing social events for the cultural ambassador participant(s) to attend and/or the cultural ambassador participant(s) attending social events, which may occur at more than one point and/or be more than one step that occurs throughout the program, and which may facilitate other steps, such as the adaptation exchange step;
(H) providing outbound exchange for the cultural ambassador participant(s) to deliver information to the host, to students, and/or to non-cultural ambassador participant(s) of the program;
(I) providing professional development for the participant(s);
(J) providing additional opportunities for the cultural ambassador participant(s);
(K) the cultural ambassador participant(s) returning to their respective home countries; and
(L) providing an alumni network for cultural ambassador participant(s) who have participated in the program.

16. (canceled).
